(19) United States
(12) Patent Application Publication
(10) Pub. No.: US 2026/0142847 A1
(43) Pub. Date: May 21, 2026

(54) METHODS AND APPARATUS FOR UTILIZING AN ENERGY SAVING MODE DURING A COLLABORATION SESSION

(71) Applicant: Cisco Technology, Inc., San Jose, CA (US)

(72) Inventor: Satya Prakash Agrawal, Bangalore (IN)

(21) Appl. No.: 18/953,555

(22) Filed: Nov. 20, 2024

(51) Int. Cl. H04L 12/18

(52) U.S. Cl. CPC H04L 12/1827; H04L 12/1822

(57) ABSTRACT

In one embodiment, a method includes supporting a collaboration session and communicating with a first endpoint and a second endpoint. The method also includes obtaining a first break notification that indicates a start of a break, and notifying the first endpoint and the second endpoint of the start of the break. Notifying the first endpoint and the second endpoint of the start of the break includes instructing the first endpoint to enter into a first energy saving mode and instructing the second endpoint to enter into a second energy saving mode. The first endpoint and the second endpoint are notified of an end of the break. Notifying the first endpoint and the second endpoint of the end of the break includes instructing the first endpoint to exit the first energy saving mode and instructing the second endpoint to exit the second energy saving mode.

### TECHNICAL FIELD

The present disclosure relates to saving energy during a break or intermission in a collaboration session.

### BACKGROUND

During collaboration sessions involving communication platforms, breaks or intermissions are often effectively given or arranged to enable meeting attendees to attend to needs including, but not limited to including, answering emails, consuming a meal, and/or attending to personal needs. Devices used by the attendees to attend a collaboration session typically remain “on” during a break in the collaboration session. For example, a microphone and a camera of a device used to join a collaboration session are generally left active such that sounds and images at the location of the device may continue to be captured during a break. As a result, energy may be wasted. In addition, the privacy of meeting attendees may be at risk, as their activities during a break may be monitored and/or recorded.

### BRIEF DESCRIPTION OF THE DRAWINGS

The disclosure will be readily understood by the following detailed description in conjunction with the accompanying drawings in which:

FIG. 1A is a diagrammatic representation of a collaboration platform or infrastructure in accordance with an embodiment.

FIG. 1B is a diagrammatic representation of a collaboration platform, e.g., collaboration platform 100 of FIG. 1A, with endpoints located at different locations in accordance with an embodiment.

FIG. 1C is a diagrammatic representation of a collaboration platform, e.g., collaboration platform 100 of FIG. 1A, with a plurality of endpoints located at a common locations in accordance with an embodiment.

FIG. 2 is a block diagram representation of a collaboration server, e.g., collaboration server 104 of FIGS. 1A-1C, in accordance with an embodiment.

FIG. 3 is a block diagram representation of an endpoint, e.g., endpoint 108a-n of FIGS. 1A-1C, in accordance with an embodiment.

FIG. 4 is a process flow diagram which illustrates a method of saving energy during a break in a collaboration session in accordance with an embodiment.

FIGS. 5A and 5B are a process flow diagram which illustrates a method of saving energy during a collaboration session that includes setting a timer in accordance with an embodiment.

FIG. 6 is a process flow diagram which illustrates a method of an endpoint entering an energy saving mode, e.g., step 425 of FIG. 4 and step 549 of FIG. 5B, in accordance with an embodiment.

FIG. 7 is a process flow diagram which illustrates a method of an endpoint returning to a collaboration session after being in an energy saving mode, e.g., step 437 of FIG. 4 and step 561 of FIG. 5B, in accordance with an embodiment.

FIG. 8 is a block diagram representation of a break initiation and termination module of a collaboration server, e.g., break initiation and termination module 224a of FIG. 2, in accordance with an embodiment,

FIG. 9 is a block diagram representation of an energy conservation module of a collaboration server, e.g., energy conservation module 224b of FIG. 2, in accordance with an embodiment.

FIG. 10 is a block diagram representation of an energy conservation module of an endpoint, e.g., energy conservation module 338 of FIG. 3, in accordance with an embodiment.

FIG. 11 is a hardware block diagram of a networking/computing device/apparatus/appliance/endpoint that may perform functions associated with any combination of operations in connection with the techniques described with respect to FIGS. 1A-1C , FIGS. 2-4, FIG. 5A, FIG. 5B, and FIGS. 6-11.

### DETAILED DESCRIPTION

### Overview

Techniques are presented herein that enable endpoints participating in a collaboration session to enter into an energy conservation or energy saving state when the collaboration session is paused, e.g., during a break or an intermission. During the pause, by substantially automatically turning off microphones and cameras, dimming screens, and/or pausing recordings associated with the endpoints, energy may be conserved and, additionally, privacy concerns may be substantially mitigated. When the pause ends, the endpoints may be substantially automatically returned to the collaboration session. For example, microphones and cameras may be turned on, and screens may be un-dimmed when the pause is over.

According to one aspect, a method includes supporting a collaboration session using a server, wherein supporting the collaboration session includes the server communicating with a first endpoint and a second endpoint, the first endpoint being at a first location, the second endpoint being at a second location. The method also includes obtaining a first break notification on the server, the first break notification being arranged to indicate at least a start of a break during the collaboration session, and notifying the first endpoint and the second endpoint of the start of the break. Notifying the first endpoint and the second endpoint of the start of the break includes instructing the first endpoint to enter into a first energy saving mode and instructing the second endpoint to enter into a second energy saving mode. The first endpoint and the second endpoint are notified of an end of the break during the collaboration session, wherein notifying the first endpoint and the second endpoint of the end of the break includes instructing the first endpoint to exit the first energy saving mode at the end of the break and instructing the second endpoint to exit the second energy saving mode at the end of the break.

In accordance with another aspect, an apparatus includes one or more network processor units to communicate with devices in a network, and a processor coupled to the one or more network processor units. The processor is configured to perform: supporting a collaboration session, wherein supporting the collaboration session includes communicating with a first endpoint and a second endpoint, the first endpoint being at a first location, the second endpoint being at a second location, and obtaining a first break notification on the server, the first break notification being arranged to indicate at least a start of a break during the collaboration session. Additionally, the processor is configured to perform notifying the first endpoint and the second endpoint of the start of the break, wherein notifying the first endpoint and the second endpoint of the start of the break includes instructing the first endpoint to enter into a first energy saving mode and instructing the second endpoint to enter into a second energy saving mode, and notifying the first endpoint and the second endpoint of an end of the break during the collaboration session, wherein notifying the first endpoint and the second endpoint of the end of the break includes instructing the first endpoint to exit the first energy saving mode at the end of the break and instructing the second endpoint to exit the second energy saving mode at the end of the break.

According to still another aspect, one or more non-transitory computer readable storage media encoded with instructions that, when executed by a processor, cause the processor to perform supporting a collaboration session, wherein supporting the collaboration session includes communicating with a first endpoint and a second endpoint, the first endpoint being at a first location, the second endpoint being at a second location, and obtaining a first break notification, the first break notification being arranged to indicate at least a start of a break during the collaboration session. The processor also performs notifying the first endpoint and the second endpoint of the start of the break, wherein notifying the first endpoint and the second endpoint of the start of the break includes instructing the first endpoint to enter into a first energy saving mode and instructing the second endpoint to enter into a second energy saving mode, and notifying the first endpoint and the second endpoint of an end of the break during the collaboration session, wherein notifying the first endpoint and the second endpoint of the end of the break includes instructing the first endpoint to exit the first energy saving mode at the end of the break and instructing the second endpoint to exit the second energy saving mode at the end of the break.

### Example Embodiments

Conserving energy enables energy resources to be utilized efficiently. The ability to conserve energy while collaboration sessions, as for example virtual meetings, may prevent wasting energy unnecessarily. For example, pauses such as breaks may be scheduled or otherwise initiated during a collaboration session to allow meeting attendees to at least briefly step away from the collaboration session without missing any part of the collaboration session. During such pauses, resources such as microphones and cameras may be left on, thereby effectively wasting energy while no attendees of the collaboration session are speaking or presenting content.

By substantially automatically causing resources such as microphones and cameras to be deactivated for the duration of a break during a collaboration session, energy may be conserved. Within a collaboration platform, a collaboration server that supports a collaboration session may, when an administrator or other meeting attendee with permission to pause the collaboration session, notify endpoints participating in the collaboration session to save energy, e.g., by turning off microphones and cameras which will not being used during the pause. When the pause is over, endpoints participating in the collaboration session may automatically return to the state that endpoints were in prior to the pause. In general, the collaboration session is still ongoing during the pause, but resources such as microphones and cameras may be deactivated to conserve energy during the pause. For example, attendees may remain logged into the collaboration session through their associated endpoints for the duration of the pause while microphones, cameras, and the like included in the endpoints are temporarily deactivated during the pause.

In addition to enabling energy to be conserved, by deactivating microphones, cameras, and the like that are associated with endpoints during a break in a collaboration session, the privacy associated with the locations at which the endpoints are located may be protected. For example, an attendee or participant in the collaboration session may forget, or otherwise be unaware, when the microphone and/or camera on his or her endpoint are active during a break in a collaboration session, and therefore inadvertently compromise his or her privacy. When microphones, cameras, and the like associated with endpoints are deactivated during a break in a collaboration session, an attendee or participant in the collaboration system is not at risk of accidentally compromising his or her privacy. When a microphone, camera, and the like are effectively deactivated during a break in a collaboration session, activities of the attendee during the break are not captured by the microphone and/or the camera.

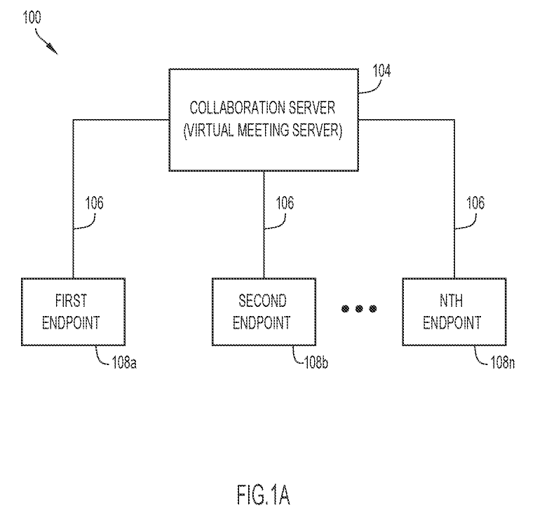

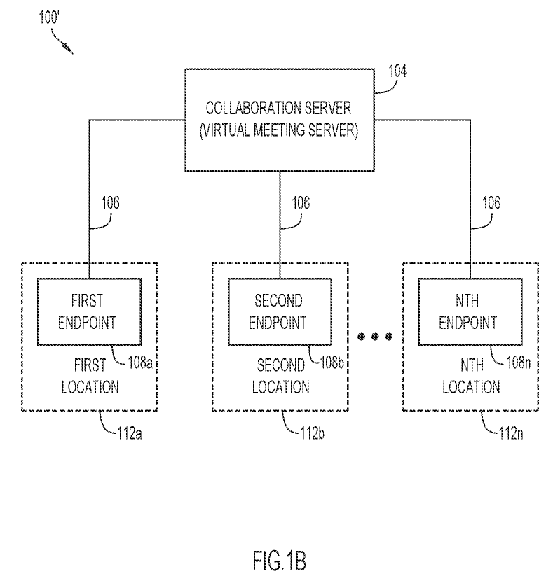

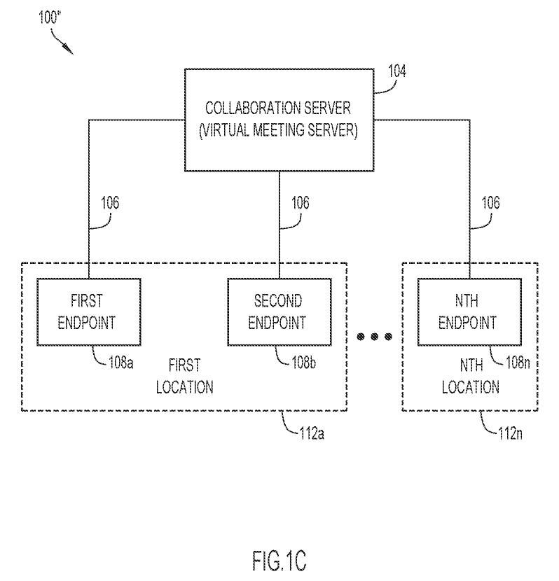

FIG. 1A is a diagrammatic representation of a collaboration platform or infrastructure in accordance with an embodiment. A collaboration platform 100, or a collaboration infrastructure, includes a collaboration server 104 which may initiate, manage, and terminate a collaboration session. Collaboration server 104 may generally be a virtual meeting server. A collaboration session may generally include a meeting session, e.g., a virtual meeting session, during which content may be shared such that collaboration may occur.

Collaboration server 104 may be hosted on the cloud, and may be distributed within the cloud. That is, collaboration server 104 may be distributed among one or more servers in the cloud. A plurality of endpoints 108a-n may participate in a collaboration session hosted or otherwise supported by collaboration server 104. Endpoints 108a-n may be devices which enable participation, e.g., by attendees of the collaboration session, in the collaboration session. Endpoints 108a-n may include, but are not limited to including, video conferencing equipment, computing devices, smart phones, tablets, and the like. As shown, first endpoint 108a, second endpoint 108b, and nth endpoint 108n participate in a collaboration session hosted by collaboration server 104. It should be appreciated, however, that the number of endpoints 108a-n participating in a collaboration session may vary widely.

Endpoints 108a-n generally communicate with collaboration server 104 over one or more network connections 106 or media channels, as for example wireless network connections. The communication between endpoints 108a-n and collaboration server 104 involves exchanging data or information over network connections 106. In general, endpoints 108a-n may be located at substantially any physical location. FIG. 1B is a diagrammatic representation of collaboration platform 100 with endpoints 108a-n located at different locations in accordance with an embodiment. Within collaboration platform 100’, first endpoint 108a may be located at a first location 112a, second endpoint 108b may be located at a second location 112b, and nth endpoint 108n may be located at an nth location 112n.

Although a single endpoint 112a-n may be at each location 112a-n, it should be appreciated that more than one endpoint 112a-n may be present at a single location 112a-n. For example, if first location 112a is a conference room that is allocated for, e.g., reserved for, a particular collaboration session, endpoints 112a-n corresponding to more than one attendee may be located at first location 112a. As shown in FIG. 1C, collaboration platform 100” includes first location 112a at which first endpoint 108a and second endpoint 108b may be located, and nth location 112n at which nth endpoint 108n is located.

In one embodiment, first location 112a may be a primary or main location associated with a conference session. For example, first endpoint 108a may include video conferencing equipment such as a dedicated meeting device that has one or more cameras, one or more microphones, and one or more display screens. That is, first endpoint 108a may be a primary endpoint, and first location 112a may be a primary location. When first location 112a is a location at which multiple attendees may be present during a collaboration session, substantially all attendees may participate in the collaboration session using first endpoint 108a. At least one of the attendees at first location 112a may be in possession of second endpoint 108b, e.g., at least one attendee may be logged into the collaboration session on his or her own endpoint. In other words, although first endpoint 108a may include video conferencing equipment that may effectively be used by multiple attendees at first location 112a to participate in a collaboration session, second endpoint 108b may also be located at first location 112a. Nth endpoint 108n may be considered to be a remote endpoint relative to first location 112a. That is, nth location 112n may be remote with respect to first location 112a and, hence, nth endpoint 108n may be a remote endpoint.

During a collaboration session, a pause such as a break, intermission, hiatus, respite, breather, etc., may be instituted or otherwise introduced to provide attendees with an opportunity to effectively leave the collaboration session for the duration of the pause. A pause may be for a predetermined amount of time, and may be established by an owner or administrator of a collaboration session. In one embodiment, when a pause in a collaboration session is indicated, energy conservation or energy saving methods may be substantially automatically triggered with respect to endpoints 108a-n.

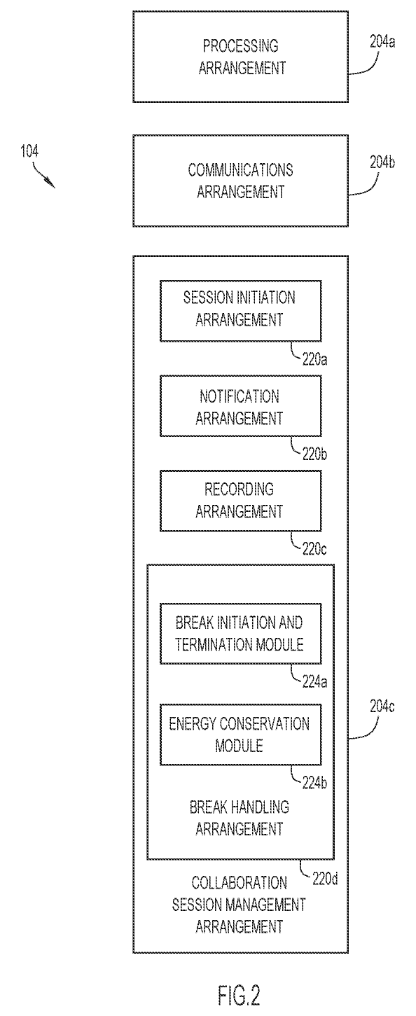

Collaboration server 104 is configured to cause an energy saving mode to be initiated with respect to endpoints 108a-n when a break is indicated during a collaboration session. In other words, when an attendee with authority to initiate a break during a collaboration session, e.g., a host of the collaboration session, indicates to collaboration server 104 that a break is to commence, collaboration server 104 may effectively signal endpoints 108a-n to enter into an energy saving mode. With reference to FIG. 2, collaboration server 104 will be described in accordance with an embodiment. Collaboration server 104 includes a processing arrangement 204a, a communications arrangement 204b, and a collaboration session management arrangement 204c. Processing arrangement 204a is generally arranged to execute code devices, logic, and/or software associated with collaboration session management arrangement 204c. Communications arrangement 204b is configured to enable collaboration server 104 to communicate on a network, as for example with endpoints 108a-n of FIGS. 1A-C.

Collaboration session management arrangement 204c includes a session initiation arrangement 220a, a notification arrangement 220b, a recording arrangement 220c, and a break handling arrangement 220d. Session initiation arrangement 220a is configured to enable a collaboration session, e.g., a video conference, to be initiated. For example, session initiation arrangement 220a may facilitate coordinating endpoints 108a-n of FIGS. 1A-1C joining a collaboration session. Notification arrangement 220b is configured to enable notifications associated with a collaboration session to be generated, and to be provided to endpoints 108a-n of FIGS. 1A-1C via communications arrangement 204b. For example, notification arrangement 220b may generate a notification which indicates that an energy-saving mode is to be entered.

Break handling arrangement 220d may include a break initiation and termination module 224a and an energy conservation module 224b. Break initiation and termination module 224a is configured to initiate a break during a collaboration session, and to terminate or to otherwise end the break during the collaboration session. It should be appreciated that initiating a break during a collaboration session does not include ending the collaboration session, and that terminating the break during a collaboration session does not include restarting the collaboration session. In other words, a collaboration session may effectively be in an active state prior to initiating a break, and may effectively be in an inactive state during a break. It should be appreciated that a collaboration session which is in an inactive state is such that attendees effectively remain logged into the collaboration session during a break, and network connections or media connections associated with the collaboration session remain intact, as for example through the use of keep-alive messages. It should be appreciated that in a media session, when media is not being transmitted, the media session is considered to be inactive, and keep-alive messages may be sent to keep the media session alive by substantially preventing termination of the media session. Energy conservation module 224b is configured to essentially specify measures to be taken by endpoints such as endpoints 108a-n of FIGS. 1A-C to conserve or to save energy, e.g., to enter into an energy savings mode. In one embodiment, energy conservation module 224b may be arranged to cause notification arrangement 220b to generate a notification which indicates that an energy saving mode is to be entered.

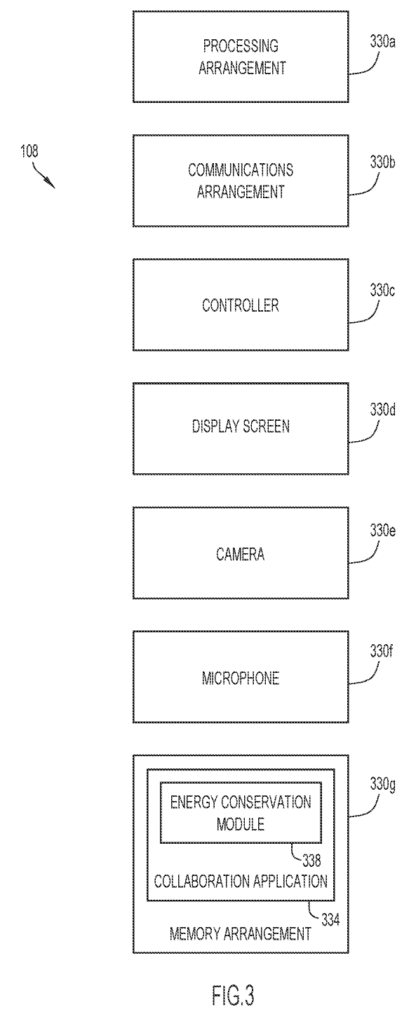

Referring next to FIG. 3, an endpoint, e.g., endpoint 108a-n of FIGS. 1A-C, will be described in accordance with an embodiment. An endpoint 108 includes a processing arrangement 330a, a communications arrangement 330b, a controller 330c, a display screen 330d, a camera 330e, a microphone 330f, and a memory arrangement 330g in which a collaboration application 334 is stored or instantiated. Processing arrangement 330a is configured to execute code devices, logic, and/or software associated with controller 330c and collaboration application 334. Communications arrangement 330b enables endpoint 108 to obtain information from and to provide information to a network, e.g., a wireless network. Controller 330c is arranged to cooperate with processing arrangement 330a and collaboration application 334 to issue commands or instructions to display screen 330d, camera 330e, and/or microphone 330f. For example, controller 330c may effectively cause the brightness associated with display screen 330d to be altered, cause camera 330e to turn on and off, and to cause microphone 330f to turn on and off.

Collaboration application 334 is generally arranged/configured to enable endpoint 108 to participate in a collaboration session hosted by a collaboration server, e.g., collaboration server 104 of FIGS. 1A-C. In the described embodiment, collaboration application 334 includes an energy conservation module 338 that is configured to cause endpoint 108 to enter into an energy saving mode. For example, upon obtaining or otherwise receiving a notification from a collaboration server such as collaboration server 104 of FIGS. 1A-1C that a break is commencing during a collaboration session, energy conservation module 338 may cause controller 330c to adjust settings associated with display screen 330d, camera 330e, and/or microphone 330f as appropriate.

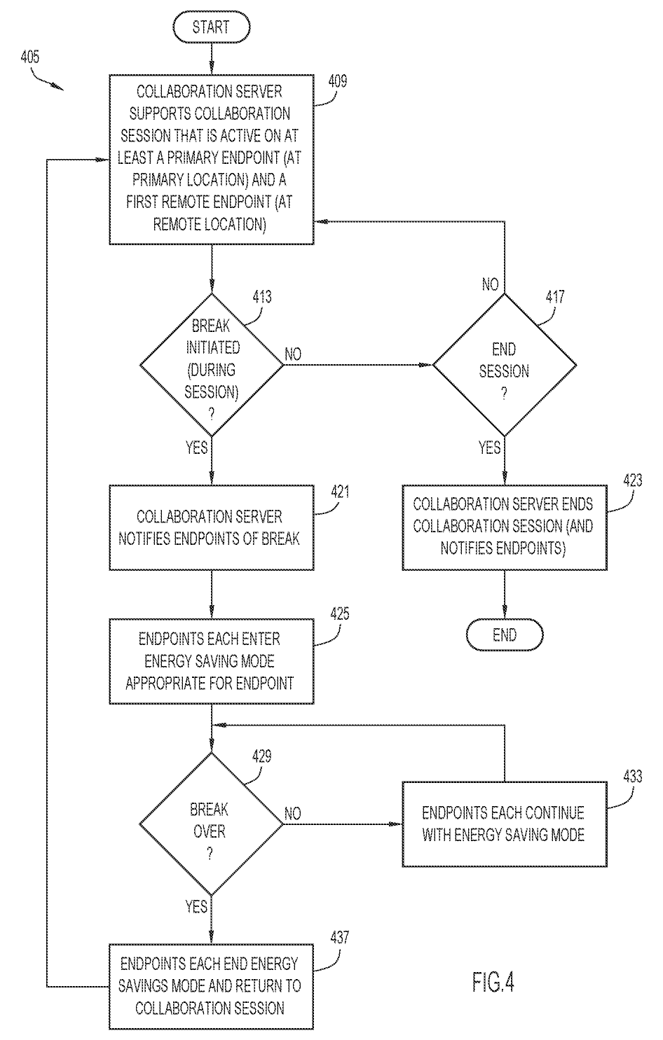

FIG. 4 is a process flow diagram which illustrates a general method of saving energy during a break in a collaboration session, or a general method of utilizing an energy-saving mode during a break in a collaboration session, in accordance with an embodiment. A method 405 of saving energy during a break in a collaboration session begins at a step 409 in which a collaboration server supports a collaboration session that is active on at least a primary endpoint and a first remote endpoint. The primary endpoint may be at a primary location, e.g., the primary endpoint may be video conference equipment located in a room designated as the primary location for a collaboration session. The first remote endpoint may be any endpoint that is not located at the primary location.

In a step 413, a determination is made as to whether a break is initiated during the collaboration session. That is, it is determined whether an administrator or an attendee of the collaboration session with permission to initiate a break, e.g., a host, has initiated a break.

If the determination in step 413 is that a break has not been initiated, it is determined in a step 417 whether the collaboration session is to end. If the determination is that the collaboration session is to end, the collaboration server ends the collaboration session in a step 423. The collaboration server may also notify substantially all endpoints, including the primary endpoint and the first remote endpoint, that the collaboration session has ended. Upon notifying the endpoints, the method of saving energy during a break in a collaboration session ends.

Alternatively, if it is determined in step 417 that the collaboration session is not to end, the indication is that the collaboration session is to continue. As such, process flow moves from step 417 back to step 409 in which the collaboration server continues to support the collaboration session.

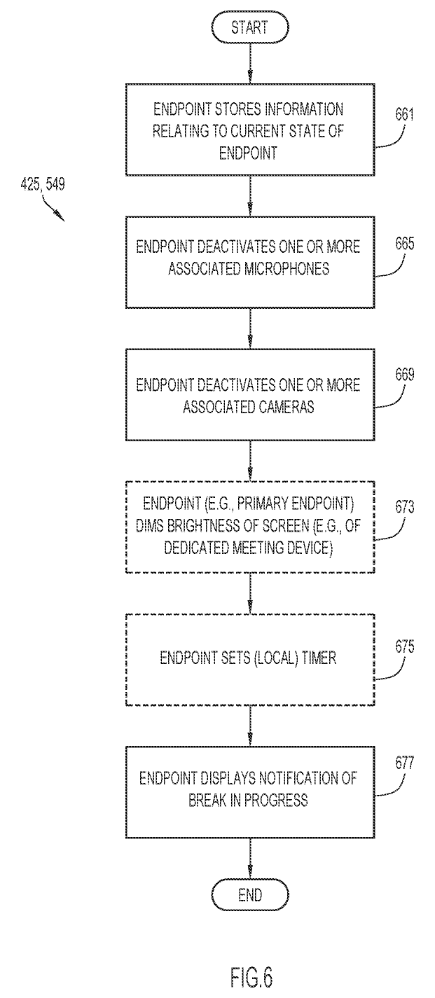

Returning to step 413, if it is determined that a break has been initiated during the collaboration session, the collaboration server notifies endpoints of the break in a step 421. The notification of a break may include, in one embodiment, an instruction or a command for the endpoints to enter into an energy saving mode. After the endpoints are notified of the break, the endpoints each enter into an energy saving mode that is appropriate for the particular endpoint in a step 425. For example, for an endpoint that includes video conferencing equipment, an energy saving mode may involve dimming a display screen, whereas screens of endpoints that are laptop computers may not be dimmed in an energy saving mode to enable the endpoints to be used during the break. One method of an endpoint entering into an energy saving mode will be discussed below with respect to FIG. 6.

A determination is made in a step 429 as to whether the break is over. If it is determined in step 429 that the break is not over, the endpoints each continue with energy saving mode in a step 433. Process flow then returns to step 429 and the determination of whether the break is over.

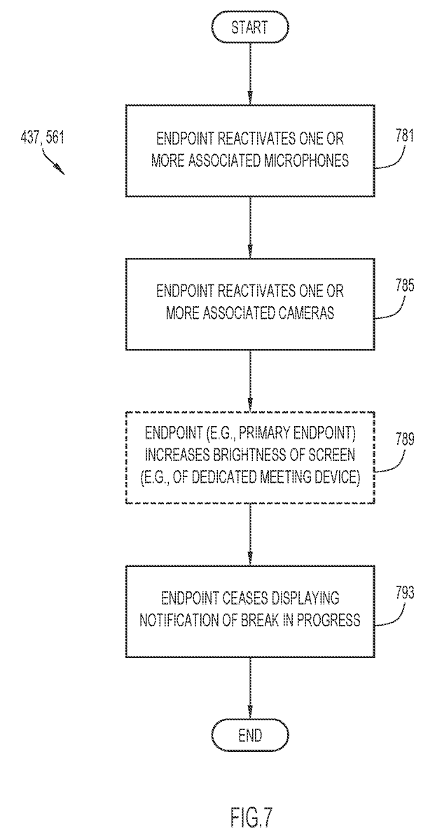

Alternatively, if the determination in step 429 is that the break is over, the endpoints each end energy saving mode in a step 437. Ending or otherwise exiting energy saving mode may generally involve returning to a “standard” or non-energy saving mode or, more generally, returning to a state of the collaboration session as it was when the break was initiated. One method of ending energy saving mode will be discussed below with respect to FIG. 7. After the endpoints each end energy saving mode, process flow returns to the collaboration session in a step 437. Once the endpoints return to the collaboration session, process flow returns to step 409 in which the collaboration server supports the collaboration session.

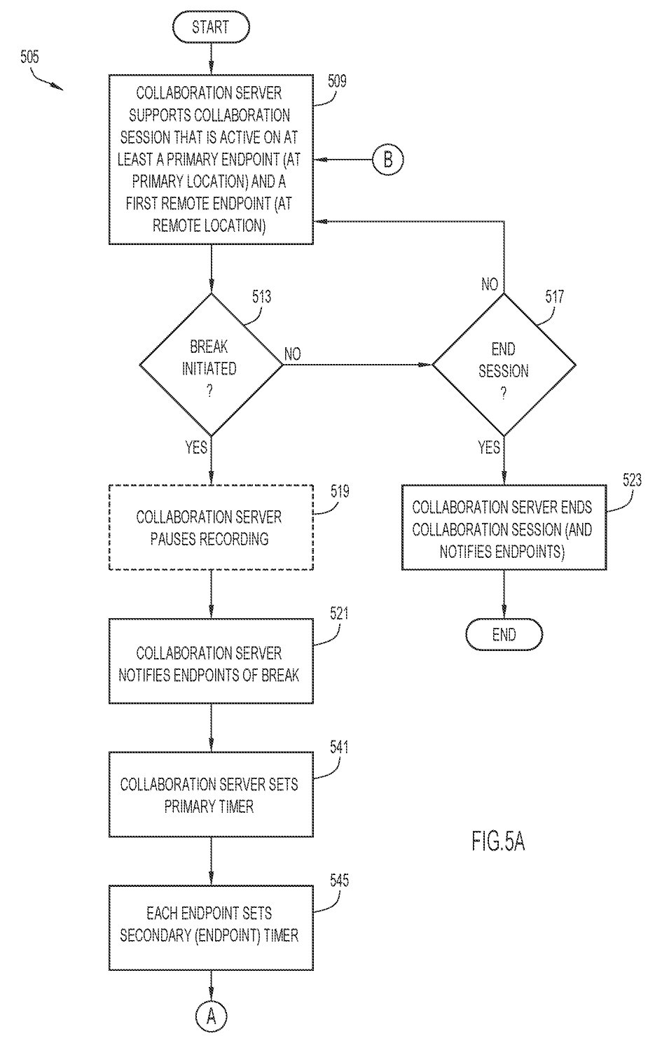

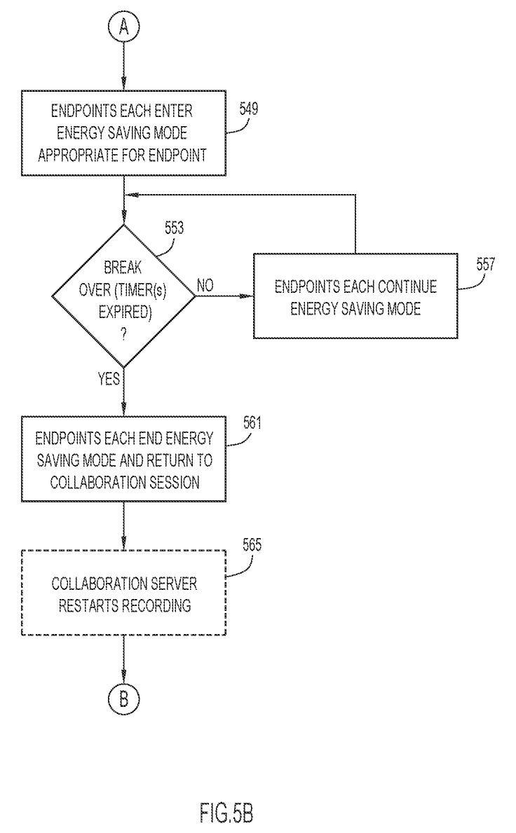

FIGS. 5A and 5B depict a process flow diagram which illustrates a particular method of saving energy during a break in a collaboration session in accordance with an embodiment. A method 505 of saving energy during a break in a collaboration session begins at a step 509 in which a collaboration server supports an active collaboration session on a plurality of endpoints including, but not limited to including, a primary endpoint located at a primary location and a first remote endpoint located at a remote location.

In a step 513, a determination is made as to whether, while the collaboration session is active, a break has been initiated. If the determination is that a break has not been initiated, process flow moves to a step 517 in which it is determined whether the collaboration session is to be ended. If it is determined that the collaboration session is not to be ended, process flow returns to step 509 in which the collaboration server continues to support the collaboration session. On the other hand, if it is determined that the session is to be ended, then the collaboration server ends the session in a step 523, and notifies the endpoints that the session is ended.

Referring back to step 513, if it is determined that a break has been initiated, then process flow proceeds to an optional step 519 in which the collaboration server pauses a recording of the collaboration session. It should be appreciated that, in some instances, a collaboration server may not record a collaboration session. When a break is initiated during a collaboration session, and for the duration of the break, keep-alive messages may be utilized by the collaboration server to substantially maintain a media channel such that the collaboration session may continue.

In a step 521, the collaboration server notifies the endpoints of a break in the collaboration session. When the collaboration server notifies the endpoints of the break, the collaboration server may effectively instruct the endpoints to enter into an energy saving mode. Such an instruction may include, but is not limited to including, a command to deactivate one or more microphones, a command to deactivate one or more cameras, a command to reduce an intensity or brightness of a display screen, a command to set a local countdown timer, and/or a command to display a notification that a break is in progress. It should be understood that a single instruction may include a plurality of commands and, as such, when the endpoints receive or otherwise obtain the instruction, the endpoints effectively have the responsibility to execute the plurality of commands.

After the collaboration server notifies the endpoints of a break, the collaboration server sets a primary timer in a step 541. The primary timer is typically a countdown timer which counts down the duration of the break. By way of example, if the break is scheduled to be M minutes long, the primary timer may effectively count down from M minutes until the primary timer expires at approximately zero minutes. The use of a timer enables a collaboration server and endpoints to determine how much longer a break in a collaboration session may be. In one embodiment, the primary timer may be displayed on a display screen associated with each endpoint to enable meeting attendees to readily identify how much time remains during a break, or how much time is left before the collaboration session resumes.

Once the collaboration server sets the primary timer, each endpoint sets a secondary or endpoint timer in a step 545. The secondary timer set by each endpoint may be maintained on each endpoint. While the primary timer essentially identifies how much time remains before a break during a collaboration session concludes, in the event of a network issue, the secondary timer may be used as a backup time. For example, if an endpoint loses a signal from the collaboration server during a break, and information about the primary timer becomes at least temporarily inaccessible, the secondary timer may be used to approximate how much time remains on the primary timer. As such, even if an endpoint is unable to access the primary timer, the endpoint may use the secondary timer to determine approximately when the break is over and, hence, when the endpoint may return to the collaboration session.

After each endpoint sets a secondary time, the endpoints each enter into an energy saving mode that is appropriate for the particular endpoint in a step 549. One method of endpoints entering into an energy saving mode will be discussed below with reference to FIG. 6. From step 549, process flow moves to a step 553 in which it is determined whether the break is over. Such a determination may include, but is not limited to including, determining when the primary timer has expired and/or when the secondary timer has expired.

If it is determined that the break is not over, the endpoints each continue substantially operating in energy saving mode in a step 557. Process flow then returns to step 553 in which it is determined whether the break is over.

Alternatively, if it is determined in step 553 that the break is over, the endpoints each end energy saving mode, and return to the collaboration session in a step 561. One method of ending energy saving mode will be discussed below with respect to FIG. 7. In a step 565, the collaboration server may optionally restart the recording of the collaboration session. It should be appreciated that in the event that the collaboration session was not being recorded prior to the break, the collaboration server typically will not restart or otherwise commence recording the collaboration session. After the endpoints return to the collaboration session and/or after the collaboration server optional restarts a recording, the method of saving energy during a break in a collaboration session is completed.

With reference to FIG. 6, a method of an endpoint entering an energy saving mode, e.g., step 425 of FIG. 4 and step 549 of FIG. 5B, in accordance with an embodiment. Method or step 425, as well as method or step 549 of an endpoint entering an energy saving mode begins at a step 661 in which the endpoint stores information relating to the current state of the endpoint. For example, the endpoint may store settings associated with one or more components or accessories of the endpoint including, but not limited to including, a microphone, a camera, and/or a display screen. A setting of a microphone may include information indicating whether the microphone is currently muted, a setting of a camera may include information indicating where a camera is pointed, and a setting of a display screen may include information indicating a brightness level of the display screen. In general, settings may include selections or preferences of an attendee, i.e., user selections. It should be appreciated that substantially all endpoints that are part of a collaboration session may receive or otherwise obtain a notification of a break mode, regardless of whether particular endpoints are not using a camera and/or a microphone.

After settings associated with the endpoint are stored, process flow proceeds to a step 665 in which the endpoint deactivates one or more microphones that are associated with the endpoint. Deactivating microphones may include, but is not limited to including, automatically muting the microphones and/or effectively turning off the microphones. It should be appreciated that if the microphone is already muted, the state of the microphone will not change as the microphone is effectively already deactivated.

The endpoint deactivates one or more cameras associated with the endpoint in a step 669. Deactivating a camera may generally include turning off the camera, or otherwise preventing the camera from capturing an image, e.g., a still image or a video image.

In an optional step 673, the endpoint may dim or otherwise reduce the brightness of a screen associated with the endpoint. When an endpoint includes a dedicated meeting device such as video conferencing equipment, a screen may be dimmed to save energy. However, when an endpoint is a device such as a personal computing system, a laptop computer, and/or a smart phone, a screen associated with the device may remain undimmed to enable a meeting attendee to utilize the endpoint during a break in the collaboration session. For example, because an attendee of a collaboration session may use his or her endpoint during a break in the collaboration session, a display screen of the endpoint may remain undimmed.

A local timer, as for example a countdown timer, may be set on the endpoint in an optional step 675. A local timer may effectively be a backup to a primary timer maintained by a collaboration server. In one embodiment, the local timer may be maintained such that, in the event of an issue that may prevent the endpoint from utilizing the primary timer maintained by the collaboration server, the local timer may be used. For example, as the local timer may have any suitable duration such as a duration that is slightly longer than the duration of the primary timer such that in the event that there is an issue that may inhibit the ability for the endpoint to maintain access to the primary timer, the endpoint may use the local timer to determine when to end an energy saving mode. The duration of the local timer may be, for instance, approximately five seconds longer than the duration of the primary timer, although the duration of the local timer relative to the duration of the primary timer may vary. Issues that may inhibit the ability for the endpoint to access a primary timer may include, but is not limited to including, network issues.

The endpoint displays a notification of a break in progress in 677, as for example on a display screen of the endpoint. A notification which indicates that a break is in progress enables an attendee of the collaboration session to readily determine when the break is over. In one embodiment, the notification may include a primary timer and/or a secondary timer arranged to indicate how much time is left during the break. After the endpoint displays the notification, the method of an endpoint entering an energy saving mode is completed.

With reference to FIG. 7, a method of an endpoint returning to a collaboration session after being in an energy saving mode, e.g., step 437 of FIG. 4 and step 561 of FIG. 5B, will be described in accordance with an embodiment. Method or step 437, as well as method or step 561, begins at a step 781 in which the endpoint reactivates one or more microphones, e.g., one or microphones that were deactivated when the endpoint entered an energy saving mode. In one embodiment, when one or more associated microphones are to be reactivated, an attendee or user of the endpoint may be notified that the microphones are being reactivated. In such an embodiment, the attendee may be prompted to acknowledge that the microphones are being reactivated prior to the microphones actually being reactivated, e.g., turned back on. It should be appreciated that a microphone which was muted when a break began may be reactivated in a muted state using, for example, information stored in step 661 of FIG. 6. Further, it should be appreciated that a muted microphone may draw power and, as such, a microphone that was muted when a break began may effectively be turned off during a break such that power is not drawn. A microphone that is turned off during a break may be turned back on when the break ends, and may be reactivated in a muted state.

In a step 785, the endpoint reactivates one or more associated cameras. In one embodiment, reactivating the one or more associated cameras includes implementing settings for the camera which were in place prior to the break commencing, e.g., settings stored in step 661 of FIG. 6. Reactivating the one or more cameras may include notifying an attendee of the collaboration session that the one or more cameras are about to be reactivated and/or requesting acknowledgement from the attendee that he or she is aware that the one or more cameras are being reactivated.

After one or more associated cameras are reactivated, the endpoint increases brightness of a screen in an optional step 789. The brightness of a display screen of a primary endpoint such as a dedicated meeting device may be increased or otherwise set to a level indicated by settings stored in step 661 of FIG. 6. It should be appreciated that screen brightness may instead be increased or, more generally, reset substantially immediately upon the end of a break.

In a step 793, the endpoint ceases displaying a notification of a break in progress. When a notification of a break in progress is terminated, the endpoint may begin displaying content associated with the collaboration session. For example, the endpoint may display a shared presentation and/or a current speaker. Once the endpoint ceases displaying the notification of the break in progress, the method of returning to a collaboration session is completed.

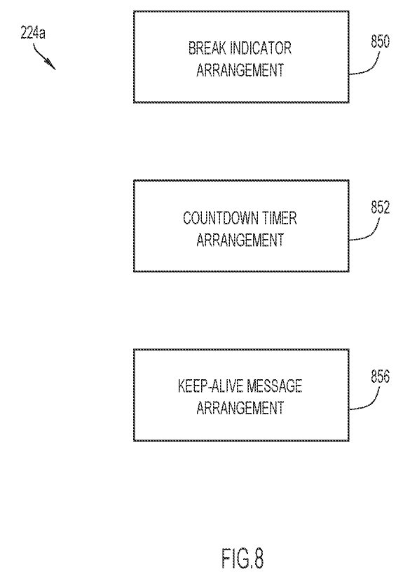

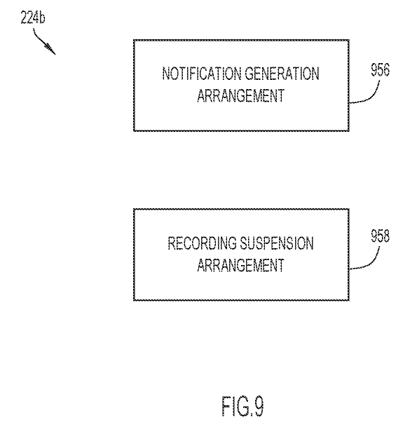

As previously mentioned, a collaboration server such as collaboration server 104 of FIGS. 1A-1C and 2, may include a break handling arrangement that includes a break initiation and termination module, as well as an energy conservation module. Break initiation and termination module 224a of FIG. 2 and energy conservation module 224b of FIG. 2 will be discussed below with reference to FIG. 8 and FIG. 9, respectively.

FIG. 8 is a block diagram representation of break initiation and termination module 224a of FIG. 2 in accordance with an embodiment. Break initiation and termination module 224a is generally configured to initiate a break and to terminate or otherwise end a break. Break initiation and termination module 224a is arranged to obtain an indication, as for example from a host such as an administrator or attendee of a collaboration session with permission to institute a break, on a break indicator arrangement 850. When a host attempts to end a break prior to a scheduled end time, the host may be prompted, e.g., on a screen of an endpoint being used by the host, break initiation and termination module 224a may prompt the host to confirm an intent to end, e.g., to abort, the break prior to the scheduled end time.

Break indicator arrangement 850 may use the indication to initiate a break. In one embodiment, the indication may include information which effectively specifies the length of the break. Break indicator arrangement 850 is configured to communicate with an energy conservation module such as energy conservation module 224b of FIG. 2 so that energy conservation module 224b may communicate with endpoints such as endpoints 108a-n of FIGS. 1A-1C to effectively instruct or to command the endpoints to enter into energy saving mode, and to exit energy saving mode.

Break initiation and termination module 224a also includes a countdown timer arrangement 852. In one embodiment, a break may be specified with either a duration or an end time. Countdown timer arrangement 852 starts a timer that effectively counts down from the beginning of the break to the end of the break. Countdown timer arrangement 852 is arranged to communicate to break indicator arrangement 850 such that break indicator arrangement 850 may communicate with an energy conservation module such as energy conservation module 224b of FIG. 2 to terminate or otherwise end an energy saving mode when the timer ends, e.g., reaches zero.

A keep-alive message arrangement 856 is included in break initiation and termination module. Keep-alive message arrangement 856 may either generate keep-alive messages that allow one or more media channels associated with a collaboration session, as well as a network address translation (NAT) layer, to remain alive or intact for the duration of a break in the collaboration session, or keep-alive message arrangement 856 may command a separate keep-alive system associated with a collaboration server such as collaboration server 104 of FIGS. 1A-1C and FIG. 2.

FIG. 9 is a block diagram representation of energy conservation module 224b of FIG. 2 in accordance with an embodiment. Energy conservation module 224b includes a notification generation arrangement 956 and a recording suspension arrangement 958. Notification generation arrangement 956 is configured to, upon receiving information that a break is either beginning or ending, generate a notification, as well as to send or otherwise provide a notification to endpoints such as endpoints 108a-n of FIGS. 1A-1C. Recording suspension arrangement 958 is configured to suspend, or otherwise pause, a recording of a collaboration session while a pause is in progress. Recording suspension arrangement 958 is further configured to restart the recording once a pause is completed. In one embodiment, recording suspension arrangement 958 may be configured to communicate with a recording service which is substantially separate from, but in communication with, a collaboration server such as collaboration server 104 of FIGS. 1A-1C and FIG. 2. That is, recording suspension arrangement 958 may notify a recording service to pause a recording of a collaboration session for the duration of a break.

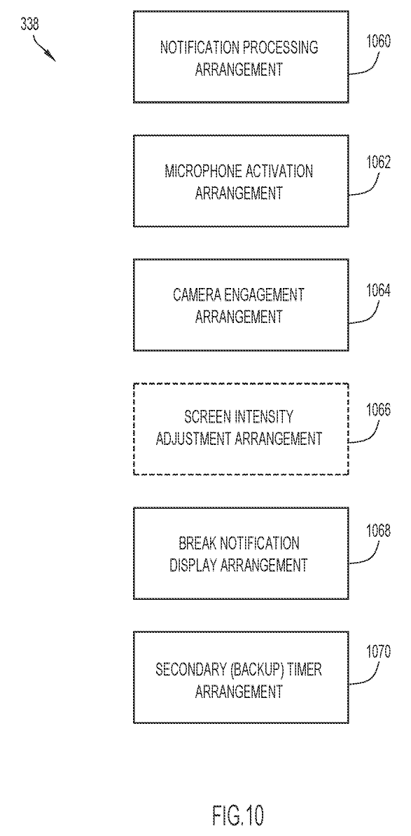

With reference to FIG. 10, an energy conservation module of an endpoint, e.g., energy conservation module 338 of endpoint 108 of FIG. 3 will be described in accordance with an embodiment. Energy conservation module 338 includes a notification processing arrangement 1060, a microphone activation arrangement 1062, a camera engagement arrangement 1064, an optional screen intensity adjustment arrangement 1066, a break notification display arrangement 1068, and a secondary timer arrangement 1070.

Notification processing arrangement 1060 is arranged/configured to obtain notifications from a collaboration server, e.g., energy conservation notifications or notifications to enter into an energy saving mode, and to determine whether notifications indicate that an energy saving mode is to be initiated or terminated. When notification processing arrangement 1060 determines that an energy savings mode is either to be initiated or terminated, notification processing arrangement 1060 may instruct microphone activation arrangement 1062, camera engagement arrangement 1064, optional screen intensity adjustment arrangement 1066, and break notification display arrangement 1068 to take action.

Microphone activation arrangement 1062 may deactivate a microphone when a break is initiated, and may activate a microphone when a break is terminated. In one embodiment, deactivating a microphone may include turning off the microphone, and activating a microphone may include turning on the microphone. In another embodiment, deactivating a microphone may involve muting the microphone while activating the microphone may involve unmuting the microphone.

Camera engagement arrangement 1064 may deactivate a camera when a break is initiated, and may activate a camera when the break is terminated. Deactivating a camera may include turning off the camera or otherwise causing the camera not to capture images. Activating a camera may include turning on the camera or otherwise causing the camera to capture images.

Optional screen intensity adjustment arrangement 1066 may enable a display screen, as for example a display screen of an endpoint that includes video conferencing equipment, to be substantially dimmed or to have reduced brightness when a break is initiated, and to have increased brightness when the break is terminated. In one embodiment, optional screen intensity adjustment arrangement 1066 may turn off a display screen to effectively dim the display screen.

Break notification display arrangement 1068 is arranged to display a notification associated with a break. The notification may include, but is not limited to including, visuals which indicate that a break is in progress or otherwise ongoing, visuals which indicate the time elapsed during a break, visuals which indicate the time remaining during a break, and/or visuals which indicate when a break is scheduled to end. In one embodiment, break notification display arrangement 1068 may display a countdown timer that is effectively maintained by a collaboration server such as collaboration server 104 of FIGS. 1A-1C and FIG. 2.

Secondary timer arrangement 1070 is configured to maintain a secondary timer that may, in one embodiment, substantially serve as a backup to a primary timer maintained by a collaboration server. Secondary timer arrangement 1070 may effectively be offset from a primary timer, e.g., secondary timer arrangement 1070 may maintain a timer that is of a slightly longer length or duration than the primary timer. As previously mentioned, a secondary timer may be arranged to be used to approximate when a break ends in the event that an endpoint is unable to access, or otherwise rely on, a primary timer.

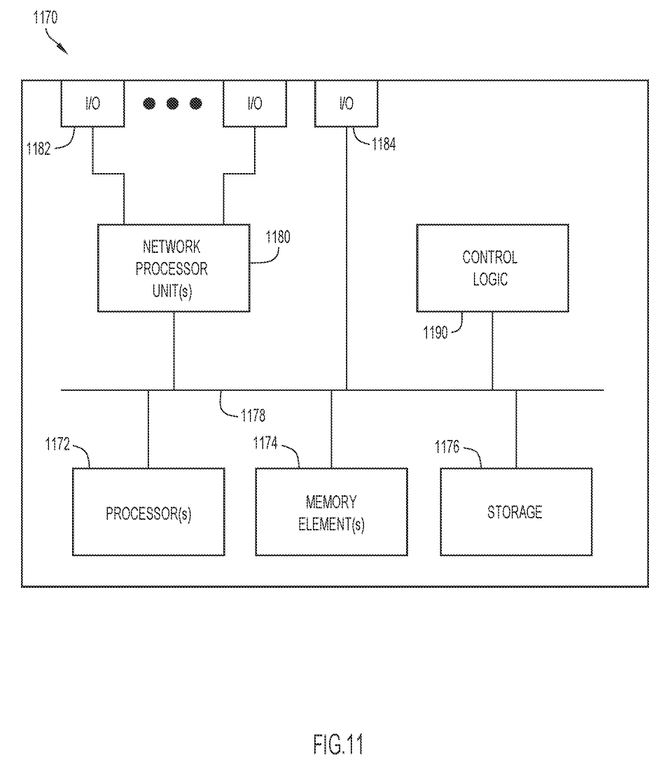

FIG. 11 is a hardware block diagram of a networking/computing device/apparatus/appliance/endpoint that may perform functions associated with any combination of operations in connection with the techniques described with respect to FIGS. 1A-1C, 2-4, 5A, 5B and 2-10. It should be appreciated that FIG. 11 provides only an illustration of one example embodiment and does not imply any limitations with regard to the environments in which different example embodiments may be implemented. Many modifications to the depicted environment may be made.

In at least one embodiment, the computing device 1170 may be any apparatus that may include one or more processor(s) 1172, one or more memory element(s) 1174, storage 1176, a bus 1178, one or more network processor unit(s) 1180 interconnected with one or more network input/output (I/O) interface(s) 1182, one or more I/O interface(s) 1184, and control logic 1190. In various embodiments, instructions associated with logic for computing device 1170 may overlap in any manner and are not limited to the specific allocation of instructions and/or operations described herein.

In at least one embodiment, processor(s) 1172 is/are at least one hardware processor configured to execute various tasks, operations and/or functions for device 1170 as described herein according to software and/or instructions configured for device 1170. Processor(s) 1172 (e.g., a hardware processor) may execute any type of instructions associated with data to achieve the operations detailed herein. In one example, processor(s) 1172 may transform an element or an article (e.g., data, information) from one state or thing to another state or thing. Any of potential processing elements, microprocessors, digital signal processor, baseband signal processor, modem, PHY, controllers, systems, managers, logic, and/or machines described herein may be construed as being encompassed within the broad term 'processor'.

In at least one embodiment, one or more memory element(s) 1174 and/or storage 1176 is/are configured to store data, information, software, and/or instructions associated with device 1170, and/or logic configured for memory element(s) 1174 and/or storage 1176. For example, any logic described herein (e.g., control logic 1190) may, in various embodiments, be stored for device 1170 using any combination of memory element(s) 1174 and/or storage 1176. Note that in some embodiments, storage 1176 may be consolidated with one or more memory elements 1174 (or vice versa), or may overlap/exist in any other suitable manner. In one or more example embodiments, process data is also stored in the one or more memory elements 1174 for later evaluation and/or process optimization.

In at least one embodiment, bus 1178 may be configured as an interface that enables one or more elements of device 1170 to communicate in order to exchange information and/or data. Bus 1178 may be implemented with any architecture designed for passing control, data and/or information between processors, memory elements/storage, peripheral devices, and/or any other hardware and/or software components that may be configured for device 1170. In at least one embodiment, bus 1178 may be implemented as a fast kernel-hosted interconnect, potentially using shared memory between processes (e.g., logic), which may enable efficient communication paths between the processes.

In various embodiments, network processor unit(s) 1180 may enable communication between computing device 1170 and other systems, entities, etc., via network I/O interface(s) 1182 (wired and/or wireless) to facilitate operations discussed for various embodiments described herein. In various embodiments, network processor unit(s) 1180 may be configured as a combination of hardware and/or software, such as one or more Ethernet driver(s) and/or controller(s) or interface cards, Fibre Channel (e.g., optical) driver(s) and/or controller(s), wireless receivers/ transmitters/transceivers, baseband processor(s)/modem(s), and/or other similar network interface driver(s) and/or controller(s) now known or hereafter developed to enable communications between computing device 1170 and other systems, entities, etc. to facilitate operations for various embodiments described herein. In various embodiments, network I/O interface(s) 1182 may be configured as one or more Ethernet port(s), Fibre Channel ports, any other I/O port(s), and/or antenna(s)/antenna array(s) now known or hereafter developed. Thus, the network processor unit(s) 1180 and/or network I/O interface(s) 1182 may include suitable interfaces for receiving, transmitting, and/or otherwise communicating data and/or information in a network environment.

I/O interface(s) 1184 allow for input and output of data and/or information with other entities that may be connected to device 1170. For example, I/O interface(s) 1184 may provide a connection to external devices such as a keyboard, keypad, a touch screen, and/or any other suitable input device now known or hereafter developed. In some instances, external devices may also include portable computer readable (non-transitory) storage media such as database systems, thumb drives, portable optical or magnetic disks, and memory cards.

In various embodiments, control logic 1190 may include instructions that, when executed, cause processor(s) 1172 to perform operations, which may include, but not be limited to, providing overall control operations of computing device; interacting with other entities, systems, etc. described herein; maintaining and/or interacting with stored data, information, parameters, etc. (e.g., memory element(s), storage, data structures, databases, tables, etc.); combinations thereof; and/or the like to facilitate various operations for embodiments described herein.

The programs described herein (e.g., control logic 1190) may be identified based upon the application(s) for which they are implemented in a specific embodiment. However, it should be appreciated that any particular program nomenclature herein is used merely for convenience, and thus the embodiments herein should not be limited to use(s) solely described in any specific application(s) identified and/or implied by such nomenclature.

In the event the device 1170 is an endpoint (such as telephone, mobile phone, desk phone, conference endpoint, etc.), then the device 1170 may further include a sound processor, a speaker that plays out audio, and a microphone that detects audio. A sound processor may be a sound accelerator card or other similar audio processor that may be based on one or more ASICs and associated digital-to-analog and analog-to-digital circuitry to convert signals between the analog domain and digital domain. In some forms, the sound processor may include one or more digital signal processors (DSPs) and be configured to perform some or all of the operations of the techniques presented herein. The device 1170 may further include a video camera.

Although only a few embodiments have been described in this disclosure, it should be understood that the disclosure may be embodied in many other specific forms without departing from the spirit or the scope of the present disclosure. By way of example, a break during a collaboration session may be instituted substantially without a specified duration. When a break does not have a specified duration, endpoints participating in the collaboration session may be commanded or otherwise instructed to enter into an energy saving mode, and may remain in the energy saving mode until the break is determined to be over. A break may be determined to be over when an administrator or attendee with authority ends a break, e.g., by providing a command to break indicator arrangement 850 of FIG. 8. When the break is determined to be over, a collaboration server may then instruct endpoints to exit the energy saving mode.

As discussed above, endpoints in a collaboration session may be placed into an energy saving mode during a break in the collaboration session. It should be understood that during a break in the collaboration session, the collaboration session is alive, ongoing, or otherwise intact. While the use of keep-alive messages has been described as being used to enable media channels or connections associated with the collaboration session to remain intact during the break, it should be used that enabling media channels or connections to remain intact during the break may be achieved using any suitable method. In other words, maintaining a collaboration session such that resources such as media channels remain associated with the collaboration session during a break may be accomplished using any suitable method.

The steps associated with entering an energy saving mode and returning from an energy saving mode may vary. For instance, the order in which the steps may be performed may vary without departing from the spirit or the scope of the present disclosure.

The arrangements and modules as discussed above may generally include, but are not limited to including, hardware, firmware, software, software logic, logic encoded on computer-readable media, hardware combined with software, digital logic gates in fixed or programmable form, etc. In other words, arrangements and modules may be embodied in a variety of different forms. By way of example, collaboration session management arrangement 204c of FIG. 2 may include hardware, software, and/or hardware combined with software.

A host may be provided with a user interface which enables the host to initiate a break during a collaboration session. The receipt of a signal from the host through such a user interface may cause a break to be initiated, and may effectively prompt a collaboration server to signal or to otherwise cause endpoints to enter into an energy saving mode such that energy may be conserved. In one embodiment, a signal from the host may be validated to substantially ensure that the host has permissions necessary to initiate a break during the collaboration session.

In various embodiments, entities as described herein may store data/information in any suitable volatile and/or non-volatile memory item (e.g., magnetic hard disk drive, solid state hard drive, semiconductor storage device, random access memory (RAM), read only memory (ROM), erasable programmable read only memory (EPROM), application specific integrated circuit (ASIC), etc.), software, logic (fixed logic, hardware logic, programmable logic, analog logic, digital logic), hardware, and/or in any other suitable component, device, element, and/or object as may be appropriate. Any of the memory items discussed herein should be construed as being encompassed within the broad term 'memory element'. Data/information being tracked and/or sent to one or more entities as discussed herein could be provided in any database, table, register, list, cache, storage, and/or storage structure: all of which may be referenced at any suitable timeframe. Any such storage options may also be included within the broad term 'memory element' as used herein.

Note that in certain example implementations, operations as set forth herein may be implemented by logic encoded in one or more tangible media that is capable of storing instructions and/or digital information and may be inclusive of non-transitory tangible media and/or non- transitory computer readable storage media (e.g., embedded logic provided in: an ASIC, digital signal processing (DSP) instructions, software [potentially inclusive of object code and source code], etc.) for execution by one or more processor(s), and/or other similar machine, etc. Generally, the storage 1176 and/or memory elements(s) 1174 may store data, software, code, instructions (e.g., processor instructions), logic, parameters, combinations thereof, and/or the like used for operations described herein. This includes the storage 1176 and/or memory elements(s) 1174 being able to store data, software, code, instructions (e.g., processor instructions), logic, parameters, combinations thereof, or the like that are executed to carry out operations in accordance with teachings of the present disclosure.

In some instances, software of the present embodiments may be available via a non- transitory computer useable medium (e.g., magnetic or optical mediums, magneto-optic mediums, CD-ROM, DVD, memory devices, etc.) of a stationary or portable program product apparatus, downloadable file(s), file wrapper(s), object(s), package(s), container(s), and/or the like. In some instances, non-transitory computer readable storage media may also be removable. For example, a removable hard drive may be used for memory/storage in some implementations. Other examples may include optical and magnetic disks, thumb drives, and smart cards that can be inserted and/or otherwise connected to a computing device for transfer onto another computer readable storage medium.

In some aspects, the techniques described herein relate to a method including: supporting a collaboration session using a server, wherein supporting the collaboration session includes the server communicating with a first endpoint and a second endpoint, the first endpoint being at a first location, the second endpoint being at a second location; obtaining a first break notification on the server, the first break notification being arranged to indicate at least a start of a break during the collaboration session; notifying the first endpoint and the second endpoint of the start of the break, wherein notifying the first endpoint and the second endpoint of the start of the break includes instructing the first endpoint to enter into a first energy saving mode and instructing the second endpoint to enter into a second energy saving mode; and notifying the first endpoint and the second endpoint of an end of the break during the collaboration session, wherein notifying the first endpoint and the second endpoint of the end of the break includes instructing the first endpoint to exit the first energy saving mode at the end of the break and instructing the second endpoint to exit the second energy saving mode at the end of the break.

In some aspects, the techniques described herein relate to a method wherein notifying the first endpoint and the second endpoint of the start of the break includes notifying the first endpoint and the second endpoint of a first timer, the first timer being arranged to indicate a duration of the break, wherein the first timer counts down from a start time associated with the start of the break to an end time associated with the end of the break.

In some aspects, the techniques described herein relate to a method wherein instructing the first endpoint to enter into the first energy saving mode includes instructing the first endpoint to perform at least one selected from a group including deactivating a first microphone, deactivating a first camera, and reducing an intensity of a first display screen.

In some aspects, the techniques described herein relate to a method wherein instructing the first endpoint to exit the first energy saving mode includes instructing the first endpoint to perform at least one selected from a group including reactivating the first microphone, reactivating the first camera, and increasing an intensity of a first display screen.

In some aspects, the techniques described herein relate to a method wherein instructing the first endpoint to enter into the first energy saving mode further includes instructing the first endpoint to display a break notification display on the first display screen.

In some aspects, the techniques described herein relate to a method wherein the first endpoint is video conferencing equipment located at a first location.

In some aspects, the techniques described herein relate to a method wherein instructing the second endpoint to enter into the second energy saving mode includes instructing the second endpoint to perform at least one selected from a group including deactivating a second microphone and deactivating a second camera.

In some aspects, the techniques described herein relate to an apparatus including: one or more network processor units to communicate with devices in a network; and a processor coupled to the one or more network processor units and configured to perform: supporting a collaboration session, wherein supporting the collaboration session includes communicating with a first endpoint and a second endpoint, the first endpoint being at a first location, the second endpoint being at a second location; obtaining a first break notification, the first break notification being arranged to indicate at least a start of a break during the collaboration session; notifying the first endpoint and the second endpoint of the start of the break, wherein notifying the first endpoint and the second endpoint of the start of the break includes instructing the first endpoint to enter into a first energy saving mode and instructing the second endpoint to enter into a second energy saving mode; and notifying the first endpoint and the second endpoint of an end of the break during the collaboration session, wherein notifying the first endpoint and the second endpoint of the end of the break includes instructing the first endpoint to exit the first energy saving mode at the end of the break and instructing the second endpoint to exit the second energy saving mode at the end of the break.

In some aspects, the techniques described herein relate to an apparatus wherein notifying the first endpoint and the second endpoint of the start of the break includes notifying the first endpoint and the second endpoint of a first timer, wherein the first timer counts down from a start time associated with the start of the break to an end time associated with the end of the break.

In some aspects, the techniques described herein relate to an apparatus wherein instructing the first endpoint to enter into the first energy saving mode includes instructing the first endpoint to perform at least one selected from a group including deactivating a first microphone, deactivating a first camera, and reducing an intensity of a first display screen.

In some aspects, the techniques described herein relate to an apparatus wherein instructing the first endpoint to exit the first energy saving mode includes instructing the first endpoint to perform at least one selected from a group including reactivating the first microphone, reactivating the first camera, and increasing an intensity of a first display screen.

In some aspects, the techniques described herein relate to an apparatus wherein instructing the first endpoint to enter into the first energy saving mode further includes instructing the first endpoint to display a break notification display on the first display screen.

In some aspects, the techniques described herein relate to an apparatus wherein the first endpoint is video conferencing equipment located at the first location.

In some aspects, the techniques described herein relate to an apparatus wherein instructing the second endpoint to enter into the second energy saving mode includes instructing the second endpoint to perform at least one selected from a group including deactivating a second microphone and deactivating a second camera.

In some aspects, the techniques described herein relate to one or more non-transitory computer readable storage media encoded with instructions that, when executed by a processor, cause the processor to perform: supporting a collaboration session, wherein supporting the collaboration session includes communicating with a first endpoint and a second endpoint, the first endpoint being at a first location, the second endpoint being at a second location; obtaining a first break notification, the first break notification being arranged to indicate at least a start of a break during the collaboration session; notifying the first endpoint and the second endpoint of the start of the break, wherein notifying the first endpoint and the second endpoint of the start of the break includes instructing the first endpoint to enter into a first energy saving mode and instructing the second endpoint to enter into a second energy saving mode; and notifying the first endpoint and the second endpoint of an end of the break during the collaboration session, wherein notifying the first endpoint and the second endpoint of the end of the break includes instructing the first endpoint to exit the first energy saving mode at the end of the break and instructing the second endpoint to exit the second energy saving mode at the end of the break.

In some aspects, the techniques described herein relate to one or more non-transitory computer readable storage media wherein notifying the first endpoint and the second endpoint of the start of the break includes notifying the first endpoint and the second endpoint of a first timer, wherein the first timer counts down from a start time associated with the start of the break to an end time associated with the end of the break.

In some aspects, the techniques described herein relate to one or more non-transitory computer readable storage media wherein instructing the first endpoint to enter into the first energy saving mode includes instructing the first endpoint to perform at least one selected from a group including deactivating a first microphone, deactivating a first camera, and reducing an intensity of a first display screen.

In some aspects, the techniques described herein relate to one or more non-transitory computer readable storage media wherein instructing the first endpoint to exit the first energy saving mode includes instructing the first endpoint to perform at least one selected from a group including reactivating the first microphone, reactivating the first camera, and increasing an intensity of a first display screen.

In some aspects, the techniques described herein relate to one or more non-transitory computer readable storage media wherein instructing the first endpoint to enter into the first energy saving mode further includes instructing the first endpoint to display a break notification display on the first display screen.

In some aspects, the techniques described herein relate to one or more non-transitory computer readable storage media wherein the first endpoint is video conferencing equipment located at the first location.

### Variations and Implementations

Embodiments described herein may include one or more networks, which can represent a series of points and/or network elements of interconnected communication paths for receiving and/or transmitting messages (e.g., packets of information) that propagate through the one or more networks. These network elements offer communicative interfaces that facilitate communications between the network elements. A network can include any number of hardware and/or software elements coupled to (and in communication with) each other through a communication medium. Such networks can include, but are not limited to, any local area network (LAN), virtual LAN (VLAN), wide area network (WAN) (e.g., the Internet), software defined WAN (SD-WAN), wireless local area (WLA) access network, wireless wide area (WWA) access network, metropolitan area network (MAN), Intranet, Extranet, virtual private network (VPN), Low Power Network (LPN), Low Power Wide Area Network (LPWAN), Machine to Machine (M2M) network, Internet of Things (IoT) network, Ethernet network/switching system, any other appropriate architecture and/or system that facilitates communications in a network environment, and/or any suitable combination thereof.

Networks through which communications propagate can use any suitable technologies for communications including wireless communications (e.g., 4G/5G/nG, IEEE 802.11 (e.g., Wi- Fi®/Wi-Fi6®), IEEE 802.16 (e.g., Worldwide Interoperability for Microwave Access (WiMAX)), Radio-Frequency Identification (RFID), Near Field Communication (NFC), Bluetooth™, mm.wave, Ultra-Wideband (UWB), etc.), and/or wired communications (e.g., T1 lines, T3 lines, digital subscriber lines (DSL), Ethernet, Fibre Channel, etc.). Generally, any suitable means of communications may be used such as electric, sound, light, infrared, and/or radio to facilitate communications through one or more networks in accordance with embodiments herein. Communications, interactions, operations, etc. as discussed for various embodiments described herein may be performed among entities that may directly or indirectly connected utilizing any algorithms, communication protocols, interfaces, etc. (proprietary and/or non-proprietary) that allow for the exchange of data and/or information.

In various example implementations, any entity or apparatus for various embodiments described herein can encompass network elements (which can include virtualized network elements, functions, etc.) such as, for example, network appliances, forwarders, routers, servers, switches, gateways, bridges, loadbalancers, firewalls, processors, modules, radio receivers/transmitters, or any other suitable device, component, element, or object operable to exchange information that facilitates or otherwise helps to facilitate various operations in a network environment as described for various embodiments herein. Note that with the examples provided herein, interaction may be described in terms of one, two, three, or four entities. However, this has been done for purposes of clarity, simplicity and example only. The examples provided should not limit the scope or inhibit the broad teachings of systems, networks, etc. described herein as potentially applied to a myriad of other architectures.

Communications in a network environment can be referred to herein as 'messages', 'messaging', 'signaling', 'data', 'content', 'objects', 'requests', 'queries', 'responses', 'replies', etc. which may be inclusive of packets. As referred to herein and in the claims, the term 'packet' may be used in a generic sense to include packets, frames, segments, datagrams, and/or any other generic units that may be used to transmit communications in a network environment. Generally, a packet is a formatted unit of data that can contain control or routing information (e.g., source and destination address, source and destination port, etc.) and data, which is also sometimes referred to as a 'payload', 'data payload', and variations thereof. In some embodiments, control or routing information, management information, or the like can be included in packet fields, such as within header(s) and/or trailer(s) of packets. Internet Protocol (IP) addresses discussed herein and in the claims can include any IP version 4 (IPv4) and/or IP version 6 (IPv6) addresses.

To the extent that embodiments presented herein relate to the storage of data, the embodiments may employ any number of any conventional or other databases, data stores or storage structures (e.g., files, databases, data structures, data or other repositories, etc.) to store information.

Note that in this Specification, references to various features (e.g., elements, structures, nodes, modules, components, engines, logic, steps, operations, functions, characteristics, etc.) included in 'one embodiment', 'example embodiment', 'an embodiment', 'another embodiment', 'certain embodiments', 'some embodiments', 'various embodiments', 'other embodiments', 'alternative embodiment', and the like are intended to mean that any such features are included in one or more embodiments of the present disclosure, but may or may not necessarily be combined in the same embodiments. Note also that a module, engine, client, controller, function, logic or the like as used herein in this Specification, can be inclusive of an executable file comprising instructions that can be understood and processed on a server, computer, processor, machine, compute node, combinations thereof, or the like and may further include library modules loaded during execution, object files, system files, hardware logic, software logic, or any other executable modules.

It is also noted that the operations and steps described with reference to the preceding figures illustrate only some of the possible scenarios that may be executed by one or more entities discussed herein. Some of these operations may be deleted or removed where appropriate, or these steps may be modified or changed considerably without departing from the scope of the presented concepts. In addition, the timing and sequence of these operations may be altered considerably and still achieve the results taught in this disclosure. The preceding operational flows have been offered for purposes of example and discussion. Substantial flexibility is provided by the embodiments in that any suitable arrangements, chronologies, configurations, and timing mechanisms may be provided without departing from the teachings of the discussed concepts.

As used herein, unless expressly stated to the contrary, use of the phrase 'at least one of', 'one or more of', 'and/or', variations thereof, or the like are open-ended expressions that are both conjunctive and disjunctive in operation for any and all possible combination of the associated listed items. For example, each of the expressions 'at least one of X, Y and Z', 'at least one of X, Y or Z', 'one or more of X, Y and Z', 'one or more of X, Y or Z' and 'X, Y and/or Z' can mean any of the following: 1) X, but not Y and not Z; 2) Y, but not X and not Z; 3) Z, but not X and not Y; 4) X and Y, but not Z; 5) X and Z, but not Y; 6) Y and Z, but not X; or 7) X, Y, and Z.

Note that in this Specification, references to various features (e.g., elements, structures, nodes, modules, components, engines, logic, steps, operations, functions, characteristics, etc.) included in 'one embodiment', 'example embodiment', 'an embodiment', 'another embodiment', 'certain embodiments', 'some embodiments', 'various embodiments', 'other embodiments', 'alternative embodiment', and the like are intended to mean that any such features are included in one or more embodiments of the present disclosure, but may or may not necessarily be combined in the same embodiments.

Each example embodiment disclosed herein has been included to present one or more different features. However, all disclosed example embodiments are designed to work together as part of a single larger system or method. This disclosure explicitly envisions compound embodiments that combine multiple previously-discussed features in different example embodiments into a single system or method.

Additionally, unless expressly stated to the contrary, the terms 'first', 'second', 'third', etc., are intended to distinguish the particular nouns they modify (e.g., element, condition, node, module, activity, operation, etc.). Unless expressly stated to the contrary, the use of these terms is not intended to indicate any type of order, rank, importance, temporal sequence, or hierarchy of the modified noun. For example, 'first X' and 'second X' are intended to designate two 'X' elements that are not necessarily limited by any order, rank, importance, temporal sequence, or hierarchy of the two elements. Further as referred to herein, 'at least one of' and 'one or more of' can be represented using the '(s)' nomenclature (e.g., one or more element(s)).

As used herein, the terms “approximately,” “generally,” “substantially,” and so forth, are intended to convey that the property value being described may be within a relatively small range of the property value, as those of ordinary skill would understand. For example, when a property value is described as being “approximately” equal to (or, for example, “substantially similar” to) a given value, this is intended to convey that the property value may be within +/- 5%, within +/- 4%, within +/- 3%, within +/- 2%, within +/- 1%, or even closer, of the given value.

Similarly, when a given feature is described as being “substantially parallel” to another feature, “generally perpendicular” to another feature, and so forth, this is intended to convey that the given feature is within +/- 5%, within +/- 4%, within +/- 3%, within +/- 2%, within +/- 1%, or even closer, to having the described nature, such as being parallel to another feature, being perpendicular to another feature, and so forth. Mathematical terms, such as “parallel” and “perpendicular,” should not be rigidly interpreted in a strict mathematical sense, but should instead be interpreted as one of ordinary skill in the art would interpret such terms. For example, one of ordinary skill in the art would understand that two lines that are substantially parallel to each other are parallel to a substantial degree, but may have minor deviation from exactly parallel.

One or more advantages described herein are not meant to suggest that any one of the embodiments described herein necessarily provides all of the described advantages or that all the embodiments of the present disclosure necessarily provide any one of the described advantages. Numerous other changes, substitutions, variations, alterations, and/or modifications may be ascertained to one skilled in the art and it is intended that the present disclosure encompass all such changes, substitutions, variations, alterations, and/or modifications as falling within the scope of the appended claims.

What is claimed is:

1. A method comprising:
supporting a collaboration session using a server, wherein supporting the collaboration session includes the server communicating with a first endpoint and a second endpoint, the first endpoint being at a first location, the second endpoint being at a second location;
obtaining a first break notification on the server, the first break notification being arranged to indicate at least a start of a break during the collaboration session;
notifying the first endpoint and the second endpoint of the start of the break, wherein notifying the first endpoint and the second endpoint of the start of the break includes instructing the first endpoint to enter into a first energy saving mode and instructing the second endpoint to enter into a second energy saving mode; and
notifying the first endpoint and the second endpoint of an end of the break during the collaboration session, wherein notifying the first endpoint and the second endpoint of the end of the break includes instructing the first endpoint to exit the first energy saving mode at the end of the break and instructing the second endpoint to exit the second energy saving mode at the end of the break.

2. The method of claim 1 wherein notifying the first endpoint and the second endpoint of the start of the break includes notifying the first endpoint and the second endpoint of a first timer, the first timer being arranged to indicate a duration of the break, wherein the first timer counts down from a start time associated with the start of the break to an end time associated with the end of the break.

3. The method of claim 1 wherein instructing the first endpoint to enter into the first energy saving mode includes instructing the first endpoint to perform at least one selected from a group including deactivating a first microphone, deactivating a first camera, and reducing an intensity of a first display screen.

4. The method of claim 3 wherein instructing the first endpoint to exit the first energy saving mode includes instructing the first endpoint to perform at least one selected from a group including reactivating the first microphone, reactivating the first camera, and increasing an intensity of a first display screen.

5. The method of claim 3 wherein instructing the first endpoint to enter into the first energy saving mode further includes instructing the first endpoint to display a break notification display on the first display screen.

6. The method of claim 3 wherein the first endpoint is video conferencing equipment located at a first location.

7. The method of claim 6 wherein instructing the second endpoint to enter into the second energy saving mode includes instructing the second endpoint to perform at least one selected from a group including deactivating a second microphone and deactivating a second camera.

8. An apparatus comprising:
one or more network processor units to communicate with devices in a network; and
a processor coupled to the one or more network processor units and configured to perform:
supporting a collaboration session, wherein supporting the collaboration session includes communicating with a first endpoint and a second endpoint, the first endpoint being at a first location, the second endpoint being at a second location;
obtaining a first break notification, the first break notification being arranged to indicate at least a start of a break during the collaboration session;
notifying the first endpoint and the second endpoint of the start of the break, wherein notifying the first endpoint and the second endpoint of the start of the break includes instructing the first endpoint to enter into a first energy saving mode and instructing the second endpoint to enter into a second energy saving mode; and
notifying the first endpoint and the second endpoint of an end of the break during the collaboration session, wherein notifying the first endpoint and the second endpoint of the end of the break includes instructing the first endpoint to exit the first energy saving mode at the end of the break and instructing the second endpoint to exit the second energy saving mode at the end of the break.

9. The apparatus of claim 8 wherein notifying the first endpoint and the second endpoint of the start of the break includes notifying the first endpoint and the second endpoint of a first timer, wherein the first timer counts down from a start time associated with the start of the break to an end time associated with the end of the break.

10. The apparatus of claim 8 wherein instructing the first endpoint to enter into the first energy saving mode includes instructing the first endpoint to perform at least one selected from a group including deactivating a first microphone, deactivating a first camera, and reducing an intensity of a first display screen.

11. The apparatus of claim 10 wherein instructing the first endpoint to exit the first energy saving mode includes instructing the first endpoint to perform at least one selected from a group including reactivating the first microphone, reactivating the first camera, and increasing an intensity of a first display screen.

12. The apparatus of claim 10 wherein instructing the first endpoint to enter into the first energy saving mode further includes instructing the first endpoint to display a break notification display on the first display screen.

13. The apparatus of claim 10 wherein the first endpoint is video conferencing equipment located at the first location.

14. The apparatus of claim 13 wherein instructing the second endpoint to enter into the second energy saving mode includes instructing the second endpoint to perform at least one selected from a group including deactivating a second microphone and deactivating a second camera.

15. One or more non-transitory computer readable storage media encoded with instructions that, when executed by a processor, cause the processor to perform:
supporting a collaboration session, wherein supporting the collaboration session includes communicating with a first endpoint and a second endpoint, the first endpoint being at a first location, the second endpoint being at a second location;
obtaining a first break notification, the first break notification being arranged to indicate at least a start of a break during the collaboration session;
notifying the first endpoint and the second endpoint of the start of the break, wherein notifying the first endpoint and the second endpoint of the start of the break includes instructing the first endpoint to enter into a first energy saving mode and instructing the second endpoint to enter into a second energy saving mode; and
notifying the first endpoint and the second endpoint of an end of the break during the collaboration session, wherein notifying the first endpoint and the second endpoint of the end of the break includes instructing the first endpoint to exit the first energy saving mode at the end of the break and instructing the second endpoint to exit the second energy saving mode at the end of the break.

16. The one or more non-transitory computer readable storage media of claim 15 wherein notifying the first endpoint and the second endpoint of the start of the break includes notifying the first endpoint and the second endpoint of a first timer, wherein the first timer counts down from a start time associated with the start of the break to an end time associated with the end of the break.

17. The one or more non-transitory computer readable storage media of claim 15 wherein instructing the first endpoint to enter into the first energy saving mode includes instructing the first endpoint to perform at least one selected from a group including deactivating a first microphone, deactivating a first camera, and reducing an intensity of a first display screen.

18. The one or more non-transitory computer readable storage media of claim 17 wherein instructing the first endpoint to exit the first energy saving mode includes instructing the first endpoint to perform at least one selected from a group including reactivating the first microphone, reactivating the first camera, and increasing an intensity of a first display screen.

19. The one or more non-transitory computer readable storage media of claim 17 wherein instructing the first endpoint to enter into the first energy saving mode further includes instructing the first endpoint to display a break notification display on the first display screen.

20. The one or more non-transitory computer readable storage media of claim 17 wherein the first endpoint is video conferencing equipment located at the first location.
